(19) United States
(12) Patent Application Publication
(10) Pub. No.: US 2021/0055229 A1
(43) Pub. Date: Feb. 25, 2021

(54) OPTOCHEMICAL SENSOR, SENSOR CAP, USE OF THE OPTOCHEMICAL SENSOR, AND METHOD FOR PRODUCING AN ANALYTE-SENSITIVE LAYER OF AN OPTOCHEMICAL SENSOR

(71) Applicant: Endress+Hauser Conducta GmbH+Co. KG, Gerlingen (DE)

(72) Inventor: Andreas Löbbert, Waldheim (DE)

(21) Appl. No.: 16/999,906

(22) Filed: Aug. 21, 2020

(30) Foreign Application Priority Data
Aug. 21, 2019 (DE) 10 2019 122 518.3
Nov. 6, 2019 (DE) 10 2019 129 924.1

(51) Int. Cl. G01N 21/80; G01N 21/64

(52) U.S. Cl. CPC G01N 21/80; G01N 21/643; G01N 2021/775; G01N 2201/105; G01N 2201/06

(57) ABSTRACT

An optochemical sensor for determining a pH of a measured medium includes a sensor membrane having an analyte-sensitive layer. The sensor membrane has a first luminophoric dye in the form of an indicator dye and a second luminophoric dye in the form or a reference dye. At least one of the two aforementioned dyes is contained in the analyte-sensitive layer, and one of the two aforementioned dyes has an inorganic framework structure. At least one inorganic or organic receptor group, which is protolyzable, is bonded to the framework structure.

### CROSS-REFERENCE TO RELATED APPLICATION

The present application is related to and claims the priority benefit of German Patent Application No. 10 2019 122 518.3, filed Aug. 21, 2019, and 10 2019 129 924.1, filed Nov. 6, 2019, the entire contents of which are incorporated herein by reference.

### TECHNICAL FIELD

The present invention relates to an optochemical sensor, a sensor cap, two uses of the optical sensor, and a method for producing an analyte-sensitive layer for the optochemical sensor.

### BACKGROUND

DE 198 29 657 A1 discloses an optochemical sensor for determining the pH of a measured medium, and also the basic measuring principle. Further sources for explaining the measuring principle are mentioned in this document, among others: O. S. Wolfbeis, Fiber Optic Chemical Sensors and Biosensors Vol. II, CRC Press 1991; S. Draxler, M. E. Lippisch, Sens. Actuators B29, 199, 1995; J. R. Lakowics, H. Szmacinski, Sens. Actuators B11, 133, 1993; J. R. Lakowics, H. Szmacinski, M. Karakelle, Anal. Chim. Acta 272 179 1993; J. Sipor, S. Bambot, M. Romauld, G. M. Carter, J. R. Lakowicz, G. Rao Anal. Biochem. 227, 309, 1995; A. Mills, Q. Chang, Analyst, 118, 839, 1993; C. Preininger, G. J. Mohr, I. Klimant, O. S. Wolfbeis, Anal. Chim. Acta, 334, 113, 1996; and U. E. Spichinger, D. Freiner, E. Bakker, T. Rosatzin, W. Sion, Sens. Actuators B11, 262, 1993.

However, the optochemical pH sensors known to date have low drift stability and a strong dependence on the ionic strength of the measured medium. Furthermore, the use of these sensors is recommended exclusively at low temperatures of less than 40° C.

A series of the currently available sensors have comparatively labile fluorophores, such as fluorescein derivatives, which already begin to drift after a short measuring time. Although other fluorophores, such as HPTS and their derivatives, have a high temperature stability, they therefore exhibit a very strong dependence on the ionic strength of a measuring solution. Over time, more and more stable fluorophores which leach less due to a lower number of polar groups have been discovered, predominantly in university research, but nevertheless the problem of drift stability still remains. Typically, such systems are stable at low temperature (T<25° C.). The drift stability increases starkly above this temperature. Drift effects occur especially in the alkaline pH range, since the solubility of the deprotonated fluorescent dyes increases at higher pH values. In addition, the measuring range of the optical sensors is limited to a pH range of 2-3 pH units.

Starting from the above-described preliminary consideration, it is now an object to provide an optochemical sensor for pH measurement which is drift-stable even at temperatures of more than 40° C., and which has a low dependence on the ionic strength of the measured medium. Furthermore, the optochemical sensor can determine the pH of a medium in a measurement range between pH=3 and pH=11.

### SUMMARY

The present invention achieves this object by providing an optochemical sensor with the features of claim 1, and via the provision of a sensor cap for the optochemical sensor. Furthermore, two special use cases are described which, with previous sensors, could not be implemented or could be implemented only in combination with further disadvantages, as well as a method for producing an analyte-sensitive layer for said sensor.

An optochemical sensor according to the invention for determining a pH of a measured medium comprises a sensor membrane with an analyte-sensitive layer. The sensor membrane has two luminophore dyes, one of which is an indicator dye and another of which is a reference dye. The luminescence of the indicator dye, especially the prompt luminescence, is influenced by the analyte, for example hydronium ions. By contrast, the reference dye is not influenced by the analyte. At least one of the two aforementioned dyes is contained in the analyte-sensitive layer.

The indicator dye may have a decay time of between 5 and 900 ns, preferably between 21 and 500 ns, especially preferably between 22 and 100 ns. The reference dye may have a decay time of more than 1 μs, preferably between 20 and 500 μs. A respective combination of a fluorophore and a phosphorophore is especially preferred as a combination of indicator dye and reference dye. The decay times refer to a measurement at room temperature (25° C.), and the change in intensity until reaching the reciprocal of the Euler number times the output intensity (1/e)*I₀ is measured given simple exponential decay behavior. The multi-exponential model is used given a plurality of decay times. The following applies: 1(t)=Σᵢaᵢe^{t/τ}^{ᵢ}, wherein I(t) is the time-dependent emission, αᵢ is a pre-exponential factor, and τᵢ is the decay time of the respective species which is excited with a light pulse.

A distinction is made between a PET (photoinduced electron transfer) and a PPT (photoinduced proton transfer). Both variants can be used in the context of the present invention, but the PET variant is preferred.

According to the invention, one of the two aforementioned dyes, preferably the indicator dye, has an inorganic framework structure, wherein at least one inorganic or organic receptor group which is protolyzable is bonded to the framework structure. The inorganic or organic receptor group may, for example, be covalently bonded to the framework structure or be bonded to the framework structure by a polymeric coating.

The inorganic framework structures enable a reduction in the dependency of the sensor on ionic strength, and a reduction in sensor drift at higher temperatures.

The receptor group is thereby arranged especially along the outer surface which faces toward the measuring medium containing the analyte and can preferably be incorporated into a polymer matrix of a polymer coating which is arranged on the framework structure.

Further advantageous embodiments of the invention are the subject matter of the dependent claims.

The receptor group can especially advantageously be formed as an amine group, phenol group, carboxylic acid group, preferably as a carboxylic acid amide and/or carboxylic acid ester group.

It is also advantageous if the framework structure comprises a semiconductor material, preferably a sulfide and/or a selenide.

In order to improve the response, the framework structure may comprise indium, zinc, copper, silver, and/or gold, preferably as semiconductor material, especially as a sulfide and/or selenide.

It is advantageous if the framework structure is formed as a mixed sulfide and/or as a mixed selenide comprising sulfides and/or selenides of indium, zinc, copper, silver, and/or gold, preferably ZnS, CuₓIn_{y}S_{z}, AgₓIn_{y}S_{z}, and/or AuₓIn_{y}S_{z}.

The indicator dye can preferably be formed as a plurality of quantum dots, especially inorganic carboxylated quantum dots.

The core and shell of a quantum dot may thus form the framework structure within the scope of the present invention. A compound comprising the receptor groups may be arranged on the shell surface and be bonded to the shell surface.

Alternatively, or additionally, the indicator dye may be formed as one or more nanowires, nanoribbons, and/or as bulk material, especially as inorganic carboxylated nanowires, nanoribbons, and/or bulk material.

At least one dye, preferably both dyes, can advantageously be embedded in a polymer matrix of the analyte-sensitive layer of the sensor membrane, especially in a silicone.

The sensor membrane can have a further layer for forming a hydrophilic medium-contacting surface. The hydrophilic surface may have a contact angle with water of less than 30°. This effect is often also referred to as “sessile drop”.

The analyte-sensitive layer may be covalently bonded as a coating on a substrate, especially be bonded to a substrate layer and/or to an optical waveguide. Such a substrate can also be a porous granulate which may be incorporated into a polymer matrix to form a layer. The substrate, if present, is thereby to be understood within the scope of the present invention as part of the sensor membrane.

The framework structure can preferably consist of carbon material, preferably as carbon nanoparticles; graphene quantum dots; nitrogen-doped carbon nanoparticles (NCNDs, also carbon-N dots); carbon nanotubes (CNTs), preferably single-walled carbon nanotubes; or mixtures thereof. At least one of the dyes, especially in the embodiment as quantum dots, can be encapsulated with an encapsulation material containing polyethylene glycol.

The reference dye is preferably selected from a group consisting of ruby red, chromium-activated yttrium aluminum borate or gadolinium aluminum borate, manganese(IV)-activated magnesium titanate, manganese(IV)-activated magnesium fluorogermanate, ruby, alexandrite, and/or europium(III)-activated yttrium oxides, especially Eu(tta)₃DEADIT, (i.e. europium(III) coordinated to a 4-[4,6-di-(1H-indazole-1-yl)-1,3,5-triazine-2-yl]-N,N-diethylaniline unit and three 4,4,4-trifluro-1-(thiophene-2-yl)-butane-1,3-dione units), wherein the aforementioned compound is preferably encapsulated in polystyrene. The preceding term “activated” is to be understood as synonymous with the term “doped”. Thus, the corresponding compounds are doped with chromium, manganese, or europium.

The sensor membrane may have a reflective layer above the analyte-sensitive layer, i.e. in the direction of a medium-contacting surface.

Furthermore, according to the invention the invention relates to a sensor cap for an optochemical sensor according to the invention which has a mechanical interface, especially a thread, for detachable, especially mechanically detachable, connection to a sensor housing of the optochemical sensor, wherein the sensor cap has the sensor membrane described above. Thus, given increasing drift the sensor membrane of the optochemical sensor can be replaced by a new sensor membrane by exchanging the sensor cap.

An especially preferred use of the optochemical sensor according to the invention is to determine a pH of a measured medium at least in the range between 4 and 7, preferably between 4 and 10, especially preferably between 2 and 12. The evaluation preferably takes place using the DLR method (DLR: dual lifetime referencing) with determination of a phase shift.

In addition, the optochemical sensor according to the invention may be used or treated in an autoclave process. The autoclaving method thereby comprises a period of at least 2 minutes at temperatures of more than 100° C., especially between 105-130° C. An impairment of the measuring properties, especially of the drift behavior of the sensor, was not thereby observed.

Furthermore, according to the invention a method for producing an analyte-sensitive layer of a sensor membrane of an optochemical sensor for pH measurement according to the invention comprises at least the following steps: a) providing the luminophore dye in the form of an indicator dye; b) applying a hydrophilic compound to the indicator dye surface, e.g. by means of a polymer coating on the indicator dye; c) providing the reference dye; d) applying the dyes to a substrate or an optical waveguide to form an analyte-sensitive layer.

The indicator dye has a decay time of between 5 and 900 ns, preferably between 20 and 500 ns, especially preferably between 20 and 100 ns. The reference dye has a decay time of more than 1 μs, preferably between 20 and 500 μs. A respective combination of a fluorophore and a phosphorophore is especially preferred as a combination of indicator dye and reference dye.

In an intermediate step, both dyes can be embedded in a polymer matrix of a coating compound, and a subsequent application of the dyes to the substrate or to the optical waveguide may take place.

### BRIEF DESCRIPTION OF THE DRAWINGS

In the following, the invention is described in detail by means of an exemplary embodiment using the attached drawings. The drawings thereby also contain several features that, taken in isolation, can be combined in an obvious way with other exemplary embodiments that are not shown. The exemplary embodiments in their entirety are thereby in no way to be understood as limiting the scope of protection of the present invention.

FIG. 1 shows a schematic exploded view of an exemplary embodiment of an optical sensor according to the invention;

FIG. 2 shows a partial section of a sectional view of a sensor cap of the optical sensor of FIG. 1;

FIG. 3 shows a schematic depiction of a variant of a layer structure of a sensor membrane;

FIG. 4 shows a schematic depiction of the structure of a quantum dot;

FIG. 5 shows a schematic diagram of a structure comprising a reference dye and quantum dots;

FIG. 6 shows a reaction equation for preparing a dye with inorganic framework structure and organic protolyzable group, e.g. carboxylic acid groups;

FIG. 7 shows schematic depictions of a plurality of variants of an analyte-sensitive layer and their arrangement on a substrate; and

FIG. 8 shows a measurement curve of a pH measurement.

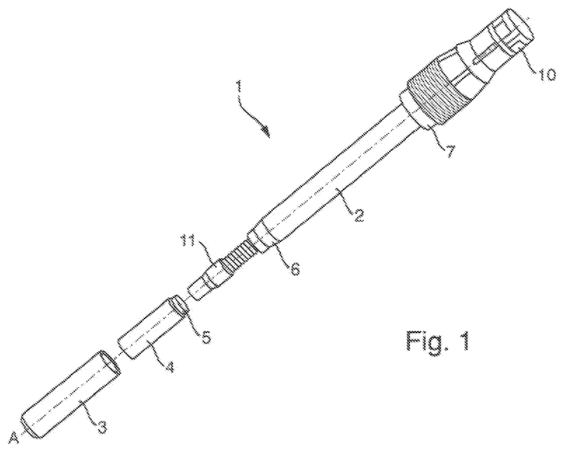

### DETAILED DESCRIPTION

An optical sensor 1 according to the invention comprises a sensor housing 2 with a plurality of housing segments, a signal source as a light source for emitting an optical signal, and a signal receiver for receiving an optical signal. These may typically be part of a receiving and transmitting unit 7.

The sensor 1 has a coupling point 10 for coupling to an evaluation unit. The coupling point 10 may provide a galvanically isolated coupling, e.g. an inductive or optical coupling.

The light source, which may comprise, for example, an LED, serves to emit an optical signal. The signal receiver serves to receive the optical signal and convert it into a current- and/or voltage-equivalent measured value. It may comprise one or a plurality of photodiodes, for example.

The optical sensor 1 has a sleeve-shaped housing section as part of the sensor housing 2, which section is connected to the receiving and transmitting unit 7. An optical conductor 11 or optical waveguide is routed within the housing section.

The sleeve-shaped housing section is connected to an optical waveguide mount 4 and a first thread 5, which is connected to a second thread 6 at the end of the housing section 2.

A sensor cap 3 is placed on the optical waveguide mount 4. The sensor cap 3 has a sensor membrane 13 in contact with the medium. The sensor cap 3 has a housing shell 14 and a longitudinal axis B which lies on the longitudinal axis A of the sensor 1. The sensor cap 3 has an annular insert 15 with which the sensor membrane 13 is pressed from the interior of a housing shell against a projection at the edge and/or a seal 21 at the edge.

In this manner, the sensor membrane 13 forms the front side 12 of the sensor cap 3 and is provided for contact with the medium to be measured.

Accordingly, the sensor membrane 13 is arranged on a front side 12 of the sensor cap 3, said front side 12 being in contact with the medium, wherein “in contact with the medium” within the scope of this invention means that the front side is in contact with the medium to be measured if the optical sensor 1 is used as intended for this purpose. The sensor membrane 13 contains a luminophore and has as a luminophore at least one fluorophore which can be embedded in a matrix material 101, for example. A phosphorophore serving as a reference dye may also be present in the sensor membrane 13, but need not be part of the membrane 13.

The measuring principle of the optical sensor 1 for pH determination is known in principle in the specialist literature and, for example, also from DE 198 29 657. It is also referred to as “dual lifetime referencing” (DLR).

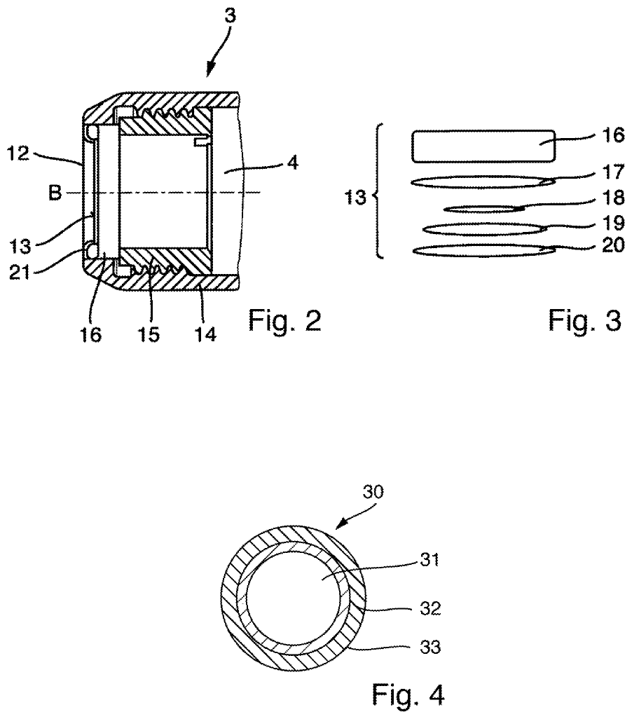

The sensor membrane 13 can have a substrate or a carrier on which layers are applied. This substrate can be made of quartz, for example. The structure of the sensor membrane is shown by way of example in FIG. 2b.

The sensor membrane 13 can include, inter alia, the luminophore-containing analyte-sensitive layer 17, a light-protective layer 18, an adhesive layer or adhesion promoter layer 19, and a cover layer 20 which simultaneously forms the end face 12 of the sensor membrane.

The cover layer 20 is thereby the layer in contact with the medium. Alternatively, or additionally, however, a proton-conducting layer may also be provided.

Optionally, an additional adhesion promoter layer can be arranged between the substrate layer 16 and the luminophore-containing analyte-sensitive layer 17. The luminophore-containing layer is also described as an analyte-sensitive layer in the context of the present invention.

The layers may be arranged in a sandwich-like manner, one above the other. However, it is also possible for individual layers to be covered or even completely encapsulated by other layers, including on the edge side.

The sensor membrane 13 can especially have the following layers: a medium-contacting layer and/or cover layer 20, and/or a first intermediate layer 19, for example an adhesive layer, and/or an optically insulating layer 18, and/or a second migration-inhibiting intermediate layer, e.g. an adhesion layer, and a luminophore-containing analyte-sensitive layer 17, and preferably a layer functioning as an adhesion promoter with respect to a substrate (16).

The luminophore-containing layer or the analyte-sensitive layer 17 is described in more detail below.

Instead of leachable organic dyes, the layer 17 can have, for example, covalently bonded quantum dots, hereinafter also called Q dots, for optical pH measurement. These Q dots have functional groups which can be formed as a type of envelope which can be protonated and deprotonated. The dye may be embedded in a matrix polymer, but should optimally not be present in different polymer domains.

The Q dots create an extremely favorable ratio of surface area to volume (example: d=1 (d=diameter), >1/6), which allows a rapid material exchange of ionic analytes (e.g. pH, K⁺, Na⁺, and NH₄⁺, NO₃⁻, . . . ). Furthermore, a covalent bond has the effect of precluding a bleaching of the dye even at higher temperatures or given basic pH values.

Suitable dyes are preferably inorganic in nature. The following are suitable: a) modified inorganic and organic quantum dots, such as carbon nanodots (C nanodots), graphene quantum dots, nitrogen-doped carbon nanodots (carbon N dots), quantum dots made of CuₓIn_{y}S_{z}, AgₓIn_{y}S_{z}, AuₓIn_{y}S_{z}, b) modified nanowires, c) modified nanoribbons, d) modified inorganic and organic semiconductors as bulk materials.

The pH can be measured by means of intensity change, and/or by determining the decay times or phase angle shifts. In optical pH measurement, the aforementioned DLR method (dual lifetime referencing) may be used. Alternatively, or additionally, only an intensity change may also be detected and the pH value determined therefrom.

A distinction is made between time domain DLR and frequency domain DLR. In the context of the present invention, both methods can be used by a control and/or evaluation unit of the optochemical sensor according to the invention.

In “frequency domain DLR”, the luminescence decay times are ascertained and evaluated. A total luminescence signal is composed of the luminescence signal of the prompt luminescences of the indicator dye, excited with an intensity-modulated signal, and of the reference dye. The phase angle represents the ratio of the amplitudes of both components. A phosphorescent dye with a decay time in the μm range is preferably used as reference dye.

In “time domain DLR”, a time-resolved luminescence measurement takes place. The signal of the indicator dye and the signal of the reference dye are excited by rectangular signals in the form of light pulses from a light source, e.g. an LED. The total signal is determined when the light source is switched on, and contains signal components of the luminescence signals of both dyes. When the light source is switched off, the luminescence signal of the fluorophore extinguishes almost immediately, whereas the luminescence signal of the phosphorophore decays slowly. The signal component of the phosphorophore in the overall signal can thereby be determined and be used as a reference for evaluating the fluorescence component.

In a simple embodiment, the indicator dye and the reference dye, mixed with an analyte-permeable polymer, are applied to a substrate surface of the substrate 16 or directly to the optical waveguide 11, e.g. an optical waveguide with contoured glass or a tapered optical waveguide, or to a special optical component, e.g. a lens. The surface can be cleaned beforehand with hydrofluoric acid or peroxomonosulfuric acid, also known as piranha solution.

In a special embodiment, the reference dye can be connected in the form of a pincushion structure to the analyte-sensitive indicator dye, especially in its embodiment as a Q dot. The indicator dye, in the form of small dye particles having an average particle size of between 1-100 nm, is thereby arranged on the reference dye having the average particle size of 1-1000 μm. The determination may take place by laser diffraction particle ion analysis, for example.

Luminophores and the like from one of the following groups can preferably be used as reference dyes: titanates, nitrides, gallates, sulfides, sulfates, aluminates, and/or silicates such as, for example, HAN Blue, HAN Purple, Egyptian Blue, and/or alumoborates, such as chromated yttrium aluminum borates.

The otherwise inorganic framework structure has receptor groups such as carboxylic acid groups and/or dopamine groups, preferably in higher density, and can be excited in the range of 400-650 nm and ideally emits light in the range between 600 and 900 nm, since a low transverse sensitivity by other fluorescent or other luminophore substances is to be expected here. However, multiphoton excitations are also conceivable within the scope of the present invention. An excitation in the infrared range, such as is used in what is known as up-conversion (in German: Photonen-Hochkonversion) fluorescent dyes, would be suitable, for example.

The structure of a preferably used quantum dot will be explained in detail below using FIG. 4.

The Q dots or quantum dots have a core-shell structure and are therefore very stably encapsulated. The construction of the Q dots 30 preferably always consists of a core 31 which consists of the fluorescent dye and a shell 32 which consists, for example, of a sulfide such as zinc sulfide. At the same time, the zinc sulfide has the function of encapsulating the dye so that it is outwardly inert. In one variant according to the invention, the dye CuₓIn_{y}S_{z} is selected. However, a dye which has a low growth-inhibiting effect on microorganisms is already selected for this dye. The shell based on ZnS acts as a protective layer, so that the heavy metals remain in the Q dots. The form of the reference dye is likewise not critical in this respect.

In the instance of FIG. 4, the Q dot is provided on its shell with a polymer coating 33 which has compounds having the functional groups or receptor groups.

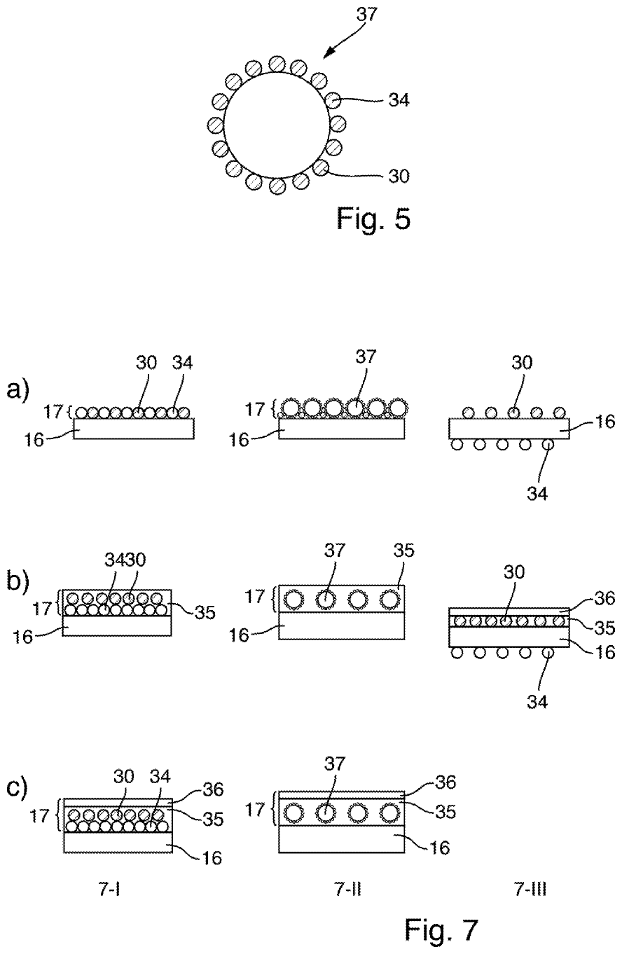

FIG. 5 shows a structure 37 as a combination of an indicator dye formed as Q dot and a reference dye 34 as what is known as a raspberry structure. The reference dye 34 is shown having the shape of a sphere; the quantum dots 30 are arranged on the surface of the reference dye 34.

A production of the quantum dots or Q dots using CuInS₂ is explained in more detail below and may also be transferred to other Q dots. First, regarding the synthesis of the CuInS₂ core: During atypical synthesis of a small amount of CuInS₂ nanoparticles, indium(III) chloride (1 mmol), thiourea (2 mmol), and 10 ml of oleylamine are transferred to a three-neck flask, and the flask is briefly evacuated and filled with inert gas. The mixture is then warmed to 80° C. until a colorless clear solution with a small amount of undissolved solid is formed. The temperature is increased to 115° C. and the solution turns yellow. A previously prepared solution of copper acetate (1 mmol) in diphenyl ether (2 ml) and dodecanethiol (2 mmol) is added and stirred vigorously. The reaction mixture is stirred at 115° C. for approximately another 1 h and then cooled slowly to room temperature. The reaction mixture is washed by precipitation with methanol/ethanol, followed by a centrifugation step at 5000 rpm for approximately 5 min. The supernatant is decanted off, resuspended in hexane (1:100) with dodecanethiol, and washed again. The process is repeated three times.

Now, using the CuInS₂ nanoparticles, a quantum dot with a ZnS shell can be prepared as follows: The core-shell nanoparticles are prepared in a manner similar to the above-described core, with the difference that a suspension of zinc stearate (0.8 mmol) in 1-octadecene (10 ml) and trioctyl phosphines (1 ml, 2.2 mmol) is added to the flask at 115° C. under an inert atmosphere. The mixture is homogenized by vigorous stirring and added to the reaction mixture at 115° C. over 6 min, and then the temperature is raised to 220° C. and stirred for 2 hours. After cooling, a precipitate is produced by addition of methanol/ethanol (3:1), which is centrifuged off and redispersed with a mixture of oleylamine:hexane (1:100). The purification is also repeated three times. The nanoparticles can then be dispersed in toluene or an alkane.

The now synthesized Q dot having a core and a shell forms the framework structure.

This Q dot is further provided with a compound having an organic or inorganic receptor group, especially on the surface of the shell. This is explained in more detail below by coating the aforementioned Q dots with a polymer having carboxylic acid groups:

Variant 1: The dispersed 0.8% CuInS₂/ZnS particles are stirred with methacrylic acid, dimethacrylic acid ethane, dimethacrylic acid butane (10 ml), and a thermal initiator such as AIBN, and crosslinked at 60° C. The encapsulated Q dots are comminuted, washed, and purified.

Variant 2: Q dots consisting of CuInS₂/ZnS and poly(maleic acid-alt-octadecene), 3 (dimethylamino)-1-propylamine are prepared as follows. Poly(maleic acid-alt-octadecene) and 3 (dimethylamino)-1-propylamine are dissolved in chloroform (10 mg/ml) and dispersed to CuInS₂/ZnS/DDT Q dots in hexane so that a molar ratio of approximately 1:30 arises. The solution is then stirred under nitrogen, and the solvent is evaporated overnight to give a film of Q dots on the bottom of the flask. Deionized water is then added and the pH is raised to pH 10 with sodium hydroxide solution, and the suspension is treated with ultrasound for 15 min. Excesses of polymer can be separated by centrifugation and/or decantation or by diafiltration through a membrane.

Variant 3a: Copper chloride (2xH₂O) (0.15 mmol) and indium chloride (4xH₂O) are dissolved in 10 ml of water, and mercaptopropionic acid (1.8 mmol) is added to the solution. The pH of the solution is adjusted to pH 11 using 2M sodium hydroxide solution. After stirring for 10 min, 0.3 mmol of thiourea are added to the mixture, and the mixture is transferred to an autoclave and autoclaved at 150° C. for 22 hours. The mixture is cooled to room temperature and then precipitated with ethanol and taken up again. The cleaning process is repeated three times. In this way, unreacted residues are removed. An MPA-capped CuInS₂ is thus prepared.

Variant 3b: A mixture of 100 mg of copper iodide (0.5 mmol), 600 mg of indium acetate (2 mmol), and dodecanethiol (20 ml) are heated in a flask to 120° C. to dissolve the starting materials. The mixture is then heated to 230° C. for 5-10 minutes and then quenched with an ice bath. The components for the shell formation of zinc stearate (20 mmol), oleic acid (15 ml), octadecane (10 ml), and dodecanethiol (4 ml) are then added and slowly heated to 230° C., and kept under inert gas for 2 h. Mercaptopropionic acid (20 ml) is then added to initiate ligand exchange. The reaction proceeds at 160° C. for a further 90 minutes and is then cooled down. In order to separate the resulting mercaptopropionic acid/Q dots from the organic solvent, buffer with pH 10 is added and the aqueous phase is separated from the organic phase. The aqueous phase is precipitated with acetone and centrifuged. The Q dots are washed several times with buffer solution and acetone and then dispersed in deionized water. An MPA-capped CuInS₂ is thus prepared.

Variant 3c: In order to obtain a more stable encapsulation, of the Q dots produced by variant 3b, a portion of the mercaptopropionic acid ligands can be replaced by mercaptoundecanol. This is done by ligand exchange. For this purpose, 50 mg of the Q dots are dispersed in 3 ml of buffer solution with pH 10, and a solution of 30 mg mercaptoundecanol in 3 ml methanol is added by drops. The mixture is stirred for 15 minutes and treated with ultrasound for a further 30 minutes. The Q dots are separated by centrifugation and washed with methanol/toluene. The precipitate is dispersed in ethanol and stored in a refrigerator. A partial ligand exchange with mercaptoundecanol has taken place.

Variant 4: Sol Gel Encapsulated Variant: Sol gel nanocomposites are prepared as follows: Tetraethoxyethane (0.25 mol), glycidoxypropyltrimethoxysilane, and ethanol (6 ml) are heated together at 80° C. under reflux for 30 minutes. The reaction mixture is then placed in an ice bath, and then 20 ml of a 3% nitric acid solution are slowly added by drops. The starting materials are then heated at 80° C. for 18 hours. The resulting Q dots solution with a charge of approximately 30 mg/ml is then added to a portion of the sol with vigorous stirring. The sol solution with mercaptopropionic acid Q dots is treated with ultrasound for one hour. 0.05 ml of a 2N sodium hydroxide solution are added to gel the sol solution, and the gel is dried or optionally applied directly to a substrate.

Variant 5: Precipitation A solution of CuInS₂/ZnS Q dots and a copolymer of polymethyl methacrylate-co-methyl acrylic acid in tetrahydrofuran is added by drops to a vessel containing water. The precipitate is homogenized with vigorous stirring, and then the nanoparticles are filtered off. Other Q dots may also be similarly encapsulated, such as InP/ZnS.

However, carboxylated quantum dots can also be purchased commercially and be covalently bound.

Finally, the polymer-coated Q dots are applied in a coating on a substrate, for example a conical geometry, or on an optical fiber. The production of such a coating composition for forming an analyte-sensitive layer takes place as follows:

Production of the Coating Compound: For the production of a covalent bond to the substrate, to the polymer matrix, or to the optical waveguide, the surface of the object to be coated is first cleaned and/or activated. The surface is then treated with APTES and reacted. In parallel, the carboxylated quantum dots are treated with EDC/NHS (N′-ethylcarbodiimide hydrochloride (EDC), N-hydroxysuccinimide (NHS)) and then stirred overnight at room temperature. The solution is added to the corresponding surface, e.g. an optical waveguide, a substrate, and/or a polymer matrix, and is amidized.

In a first alternative, the produced Q dots can react further with dopamine via amidation with EDC/NHS. These dots also have a pH sensitivity. Quinhydrones are already known as pH-sensitive redox electrodes per se, for example in combination with noble metal derivatives such as platinum.

In a second alternative, a covalent bond with histamine (2-(4-imidazolyl)-ethylamine) can be generated in the same manner as described above.

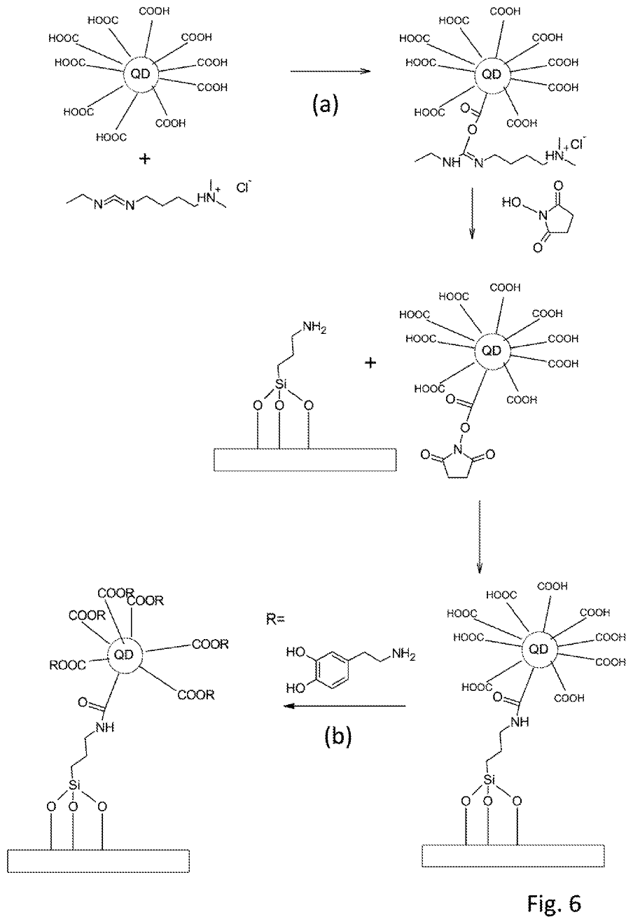

FIG. 6 respectively shows an example of a covalent bond of a Q dot to a) a product with free carboxylic acids or b) a product with dopamine or c) an organic fluorophore.

FIG. 7-I a)-c) shows a structure with a reference dye 34 and a Q dot 30 as an indicator dye in various variants. The membrane with substrate is also referred to as a sensor spot. In FIG. 7a) reference dye 34 and Q dots 30 are directly bonded covalently to the substrate 16 to form an analyte-sensitive layer 17. In FIG. 7-I b) they are bonded to the substrate 16 with an embedding matrix or polymer matrix 35 as an analyte-sensitive layer 17. In FIG. 7-I c) they are bonded to the substrate 16 in an embedding matrix 35 and with an additional optical insulation layer 36.

FIG. 7-II a)-c) shows a design having a structure 37 as shown in FIG. 5, wherein in FIG. 7-II a) this is directly bonded covalently to the substrate 16, in FIG. 7-II b) to the substrate 16 with an embedding matrix 35, and in FIG. 7-II c) to an embedding matrix 35 and to an additional optical insulation layer 36 on the substrate 16.

FIG. 7-III a) and b) show a structure with a reference dye 34 on the back side of the substrate 16 and with the Q dots 30 embedded in a membrane layer on the side of the substrate 16 facing toward the medium. An embedding matrix 35 comprising the Q dots 30 can also be overlaid here with an additional optical insulation layer 36, as illustrated in FIG. 7-III b).

The coating of the substrate can take place in layers in FIG. 7-I a)-c) or else as a mixture, FIG. 7-II a)-c). FIG. 7-II shows an aggregate, a fluorophore, and a phosphorophore in what is known as a pincushion structure, whereas in FIG. 7-I a)-c) both components are present as separate particles in a matrix. This is to be understood as a mixture in the context of this paragraph. There is no order within the mixture, and contained particles are arranged chaotically.

However, surface-structured analyte-sensitive layers, what are known as pincushion structures or raspberry structures, can also be realized within the scope of the present invention.

A sandwich structure or an island structure can also be realized within the scope of the present invention. The surface of the analyte-sensitive layer thereby has a corresponding surface structure. In this instance, for example, a respective larger-grained reference dye with smaller Q dots can be covered as fluorophore particles within the analyte-sensitive layer (see FIG. 5 or FIG. 7-II). Further layers, such as, for example, a reflector layer or an optical insulator layer or a diffusion layer or a cover layer, can also be applied over the first layer, which contains the Q dots and/or the phosphorophore as reference dye. The variation of a plurality of layers of a sensor membrane has already been discussed in the embodiment variant in the context of FIG. 3. The total thickness of the sensor membrane, that is to say the entirety of the layers, should if possible not exceed 50 μm, due to the slow diffusion speed.

Ideally, due to the formation of covalent bonds, for example to the substrate or to the optical waveguide, and the stability of the Q dots, a sequence of a plurality of layers can be dispensed with since photodegradation is rather low in the event of almost any inorganic constituents, apart from the receptor groups.

A manufacturing method for forming a first sensor membrane is disclosed below: Layer A as an analyte-sensitive layer: The surface of a substrate, for example of a quartz glass plate, is cleaned with solvent such as isopropanol or activated with piranha solution. The surface is then treated with APTES (3-aminopropyltriethoxysilane) and reacted. In parallel, carboxylated Q dots are treated with EDC/NHS and then stirred overnight at room temperature. The solution is placed on the corresponding surface of the substrate and amidized.

Layer B: An additional layer of a mixture of polyurethane D7 and TiO₂ (1:1) in THF (20 wt. %) is applied to the first layer with a doctor blade having a gap height of 30 μm.

Layer C: An additional hygienic layer consisting of polyurethane D7 in THF (20%) is applied to the two layers. A manufacturing method for forming a second sensor membrane is disclosed below:

Layer X: The surface of a substrate is cleaned with solvent such as isopropanol, or activated with piranha solution. (3-aminopropyl)triethoxysilane (APTES) is dissolved in hexane and a layer is applied to the quartz substrate via spray coating. Subsequently, Q dots dispersed in hexane (CuInS₂), with reference dye (HAN blue) in a mixing ratio (by mass) of 1:250, are applied via spray coating or blade coating, and the carboxylated Q dots are amidized via EDC/NHS at room temperature overnight. Alternatively, however, HAN blue and Q dots can also be applied in separate layers or on the back side (opposite side from the medium side) of the substrate.

Layer Y: An additional layer of a mixture of polyurethane D7 and titanium(IV) oxide TiO₂ (1:1) in tetrahydrofuran (THF, 20 wt. %) is applied to the first layer with a doctor blade having a gap height of 30 μm.

Layer Z: An additional hygienic layer consisting of D7 in THF (20%) is applied to the two layers.

In addition to the favored variant described above as copper indium sulfide (CuInS₂), however, other stoichiometric ratios are also conceivable. As an alternative to copper, other heavy metals such as silver or gold or mixtures thereof may also be used.

The Q dots of the compounds with indium in the embodiment as a sulfide and/or selenide can preferably be present as nanocrystals both in the structure as wurtzite, chalcopyrite, and/or as sphalerite.

By varying the ion ratios of the CuₓIn_{y}S₂, different intensities of the Q dots can be achieved. It has been shown that ratios of 1:2 to 2:1 of heavy metal to indium are advantageous. Thus, for example, mixtures with different mass ratios as Cuₓ/AgₓIn_{y}S_{z} are possible.

The ratio of MₓIn_{y}S_{z} may be between 1:1:6 and 0.25:1:6. The ratio of MₓIn_{y}S_{z} may preferably be between 1:1:2 and 0.25:1:2.

The ratio between heavy metal ion and indium can preferably be between 1:6 and 6:1. A small proportion of heavy metals leads if anything to a shift of the emission bands into the region of lower wavelength. Conversely, a high proportion of heavy metal in relation to the indium leads to a shift into the longer wavelength range.

For AgₓIn_{y}S_{z}, for example, ratios of 1:0.5:6 are also advantageous. Structures of the form CuInZnS are also possible as a fluorophore in the context of the present invention.

The heavy metal ion:sulfur ratio may be between 1:24 and 1:1. Variants in the form of M_{w}InₓSe_{y}S_{z} are also conceivable. In this instance, for example, the ratio of the selenium and sulfur content would be 1:1. Variants of M_{w}InₓZn_{y}S_{z} are also conceivable. In this instance, zinc belongs to the quantum dot and not to the shell. Mixtures of Q dots, for example such as AgInS₂/CuInS₂, for use as luminophore dyes are also possible within the scope of the invention.

Ideally, ZnS is used as the encapsulation material of the core, but Ag₂S or Au₂S or selenides or oxides of these metals are also conceivable.

The size of the nanoparticles or Q dots also influences the quality and the excitation behavior of the sensor membrane. According to the invention, average particle diameters of the Q dots in the range from 1 to 100 nm are sought.

The excitation wavelength can be influenced by controlling the light source. An ideal excitation wavelength lies in the visible range at wavelengths between 400-650 nm. An ideal emission wavelength is above 530 nm, preferably above 600 nm or even 650 nm. The use of what are known as “up-conversion nanoparticle Q dots” is advantageous because these can be excited at a wavelength of 530 nm and 980 nm.

The sensor membrane can be excited by an excitation of one or a plurality of photons.

The following experiments were performed with a sensor membrane comprising an analyte-sensitive layer having CuInS₂/ZnS Q dots as an indicator dye: a) Sensor drift: A drift of less than 0.1 pH was measured over a period of 6 months in a phosphate buffer solution at a pH of 7 and a temperature of 25° C. The sensor showed stable measured values even at high temperatures. b) Different pH values: A pH range between 3 and 11 could be measured. The normalized intensity change shows an approximately linear behavior over this wide pH range. The normalized intensities were lowest in the acid and increased with rising pH.

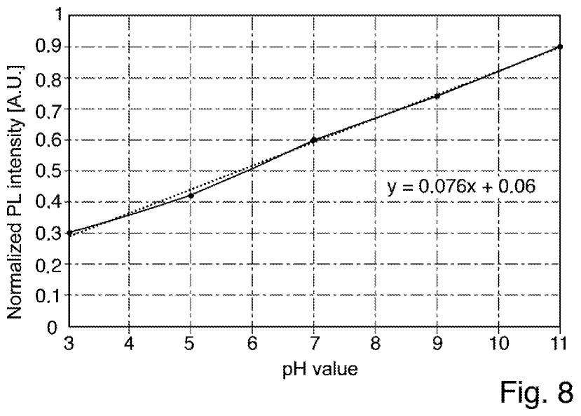

FIG. 8 shows a measurement of the normalized intensity changes (PL) as a function of the pH value.

The light (the amplitude) emitted by the Q dots as a function of the pH value is referred to as PL=photoluminescence.

The Q dots emit maximally at the maximum basic pH and minimally at the lowest pH. The maximum here is at approximately pH 12 and is set to “1”. The light is thus a relative amplitude. As can be seen from the shown characteristic curve, there is an almost linear correlation between the intensity and the pH value.

A multitude of the aforementioned Q dots are nontoxic and can thus be used without problems in medical, pharmaceutical, and food contact applications. In many applications, optochemical sensors can thus be used as advantageous alternatives to potentiometric pH sensors. Only one indicator dye and one reference dye are required for a pH range between 2 and 12.

1. An optochemical sensor for determining a pH of a measured medium, comprising:
a sensor membrane having an analyte-sensitive layer, wherein the sensor membrane has a first luminophoric dye in the form of an indicator dye and a second luminophoric dye in the form of a reference dye, wherein at least one of the first luminophoric dye and the second luminophoric dye is contained in the analyte-sensitive layer, and
wherein one of the of the first luminophoric dye and the second luminophoric dye has an inorganic framework structure, wherein at least one inorganic or organic receptor group which is protolyzable is bonded to the framework structure.

2. The optochemical sensor of claim 1, wherein the signal detection is triggered by a PET effect, wherein the indicator dye has a decay time of between 5 and 900 ns and the reference dye has a decay time of more than 1 μs.

3. The optochemical sensor of claim 1, wherein the receptor group is formed as an amine group, phenol group, or carboxylic acid group.

4. The optochemical sensor of claim 1, wherein the sensor membrane comprises a substrate.

5. The optochemical sensor of claim 1, wherein the framework structure comprises a semiconductor material.

6. The optochemical sensor of claim 1, wherein the framework structure comprises indium, zinc, copper, silver, or gold.

7. The optochemical sensor of claim 1, wherein the framework structure is formed from a mixed sulfide or mixed selenide.

8. The optochemical sensor according to claim 1, wherein one of the dyes is designed as a plurality of quantum dots.

9. The optochemical sensor of claim 1, wherein at least one dye is embedded in a polymer matrix of the analyte-sensitive layer of the sensor membrane.

10. The optochemical sensor of claim 1, wherein the sensor membrane has a layer for forming a hydrophilic medium-contacting surface which has a contact angle with water of less than 30°.

11. The optochemical sensor of claim 1, wherein the analyte-sensitive layer is covalently bonded as a coating on a substrate and/or an optical waveguide.

12. The optochemical sensor of claim 1, wherein the framework structure consists of carbon material.

13. The optochemical sensor of claim 1, wherein at least one of the dyes is encapsulated with a polyethylene glycol-containing encapsulation material as polymer coating.

14. The optochemical sensor of claim 1, wherein the reference dye is selected from a group consisting of titanate, nitride, gallate, sulfide, sulfate, aluminate, silicate, preferably made of HAN blue, HAN purple, Egyptian blue, ruby red, alumoborate, chromated yttrium aluminum borate, gadolinium aluminum borate, manganese(IV)-activated magnesium titanate, manganese(IV)-activated magnesium fluorogermanate, ruby, alexandrite, or europium(III)-activated yttria oxides.

15. The optochemical sensor of claim 1, wherein the sensor membrane has an insulation layer or a reflective layer above the analyte-sensitive layer in the direction of a medium-contacting surface.

16. The optochemical sensor of claim 1, wherein the optochemical sensor includes a sensor cap mechanically detachable from a sensor housing, wherein the sensor cap includes the sensor membrane.

17. A method for using an optochemical sensor, including:
determining a pH value of a measured medium at least in the range between 4 and 7 using the optochemical sensor,
wherein the optochemical sensor includes: a sensor membrane having an analyte-sensitive layer, wherein the sensor membrane has a first luminophoric dye in the form of an indicator dye and a second luminophoric dye in the form of a reference dye, wherein at least one of the first luminophoric dye and the second luminophoric dye is contained in the analyte-sensitive layer, and wherein one of the of the first luminophoric dye and the second luminophoric dye has an inorganic framework structure, wherein at least one inorganic or organic receptor group which is protolyzable is bonded to the framework structure.

18. A method for producing an analyte-sensitive layer of a sensor membrane of an optochemical sensor for pH measurement, including:
providing the luminophore dye in the form of an indicator dye having a decay time of between 5 ns and 900 ns;
applying a hydrophilic compound, especially a receptor and/or protic group, to the indicator dye surface;
providing the reference dye with a decay time of more than 1 μs; and
applying the dyes to a substrate or an optical waveguide to form the analyte-sensitive layer.
